(19) United States
(12) Patent Application Publication
(10) Pub. No.: US 2026/0311475 A1
(43) Pub. Date: Oct. 8, 2026

(54) SYSTEMS AND METHODS FOR IMPROVED IMAGE PROCESSING

(71) Applicant: XYSENSE PTY LTD, Melbourne, Victoria (AU)

(72) Inventors: Deep Sharma, Melbourne, Victoria (AU); Marcus Holt, Melbourne, Victoria (AU); Luke Murray, Melbourne, Victoria (AU); Florin Schimbinschi, Melbourne, Victoria (AU)

(21) Appl. No.: 19/474,927

(22) PCT Filed: Apr. 10, 2024
(86) PCT No.: PCT/AU2024/050342

§ 371 Date: Oct. 13, 2025

(30) Foreign Application Priority Data
Apr. 12, 2023 (AU) 2023901072

(51) Int. Cl. G06V 10/82; G06V 10/25; G06V 10/766; G06V 10/774; G06V 10/776

(52) U.S. Cl. CPC G06V 10/82; G06V 10/25; G06V 10/766; G06V 10/774; G06V 10/776

(57) ABSTRACT

A system and method for training (and inference) of a NN model for wide/ultra-wide angle lens object detection and positioning, the NN training module configured to receive one or more images associated with one or more images from the object recognition data set, the data set including one or more bounding box labels associated with the one or more images, apply a customized data augmentation routine on said images to create one or more augmented images in each new iteration of training, provide a predetermined neural network for computer vision model to test and train the neural network for computer vision, predict and obtain a bounding box and confidence score, each being associated with one or more objects in the one or more images from the neural network for computer vision, match ground truth bounding boxes in image space to augmentations from a box data store, apply regression loss on the bounding boxes and compute the cost between predicted values and the label values to determine change in weightings.

### TECHNICAL FIELD

The present invention relates to computer vision, deep learning and machine learning, but in particular to systems and methods for improved image processing, and in particular image processing associated with detection of objects within images from a wide/ultra-wide angle lens.

### BACKGROUND OF INVENTION

Arrangements exist for detection of objects within images by utilizing neural networks for computer vision (NNs) and the like. In recent times, applications of these arrangements are directed to object detection by way of a wide/ultra-wide angle lens for top-down “fisheye” images (to sense occupancy in buildings, public transportation and the like).

Computer vision and deep learning techniques have been utilized to detect objects (for example, individuals) and therefore gain insights on their movements within the fisheye images. This information can then be used to estimate the number of people present in a given area, providing real-time occupancy data. This data can in turn be used to optimise resource usage, improve safety and security, and support data-driven decision-making. Additionally, it can be used to support the development of smart building systems, such as automatic lighting, HVAC control, and elevator management.

It is also desirable in systems of this type to execute “at the edge”, i.e. not, for example, on a traditional server, but preferably on small, low powered devices. Many methods for doing these types of tasks are too computationally intensive and too power intensive to work within the limitations of edge computing.

Another issue is that while fisheye images capture a wide field of view (allowing for a complete view of the environment), detection of objects within images that were captured by a wide/ultra-wide angle lens is more complex than for non-wide/ultra-wide angle lens images. Owing to the optics of the wide/ultra-wide angle lens, processing on the images from the lens is required, (i.e. rotate images and the like to obtain omnidirectional images or images with extreme perspective or barrel distortion).

Issues can arise in training Neural Networks (NNs) in wide/ultra-wide angle lens applications due to types of images (or lack of types of images) to train the NNs. Attempts have been made to rotate images and the like to obtain omnidirectional images or images with perspective. An issue with these arrangements is high computational requirements and/or performance.

In the context of images from a wide/ultra-wide angle lens, an arrangement exists which utilizes single shot detection (SSD) and one or more “rotated to upright” cut-outs of an overall image (or frame from a video feed) from a wide angle lens, having a number of regions of interest (ROI's) in the image before performing, for example, a Non-Max-Suppression (NMS) technique on the ROI's. A problem with arrangements of this type is that they can suffer from requiring complex processing routines, or the inability to detect duplicates (i.e., counting objects detected in multiple ROI's more than once). Further, arrangements of this type may also have high CPU utilization during image processing.

It would be desirable to provide a system and method which ameliorates or at least alleviates one or more of the above-mentioned problems or provides a useful alternative. It would further be desirable to provide a system and method for occupancy detection via wide/ultra-wide angle lens images to more accurately determine space utilization.

A reference herein to a patent document or other matter which is given as prior art is not to be taken as an admission that the document or matter was known or that the information it contains was part of the common general knowledge as at the priority date of any of the claims.

### SUMMARY OF INVENTION

The present invention provides a method and system for object detection and accurate positioning in an image from a wide/ultra-wide angle lens which achieves accuracy and allows for deployment on embedded devices such as a FPGA. The method and system of the present invention provides methodologies and techniques used for training and inference which allows for improved operation, accuracy and deployment.

According to a first aspect, the present invention provides a method of training ‘n’ iterations over a publicly available object recognition dataset for a NN model for wide/ultra-wide angle lens object detection, the method including: (a) receiving one or more images associated with one or more images from the object recognition dataset, the dataset including one or more bounding box labels associated with the one or more images (R-T01); (b) applying a customized data augmentation routine on said images to create one or more augmented images (R-T02); (c) resizing the one or more images to a predetermined size; (R-T03); (d) providing a predetermined neural network for computer vision model to test and train the neural network for computer vision (R-T04); (e) predicting and obtaining a bounding box and confidence score, each being associated with one or more objects in the one or more images from the neural network for computer vision (R-T05); (f) matching ground truth bounding boxes in image space to augmentations from a box data store (R-T06) (R-T07); (g) applying regression loss on the bounding boxes (R-T08); (h) computing the cost between predicted values and the label values to determine change in weightings based on optimiser and learning rate scheduler states. (R-T08 and R-T09). It will be appreciated that at the end of each epoch (steps R-T10 to R-T14), the neural network is evaluated on a validation dataset. If the evaluation results show that the neural network has achieved the best scores, its weights are stored as the ‘best checkpoint’ on a disk. If not, the training proceeds to the next epoch. At the end of the final epoch, the state of the neural network is saved as the ‘last checkpoint’ on the disk. At step (f), it will be appreciated that obtaining a bounding box and confidence score may further include class predictions and multiple classes may be predicted. At step (g) it will be appreciated that regression loss may take any suitable form such as intersection over union (IoU) loss, gIoU (group), dIoU (distance) and the like.

In an embodiment, at step (f), this step can also be carried out while images are being augmented at step (b), meaning the labels are updated according to augmentations as soon as the images are augmented.

The optimized or ‘best’ weightings obtained from the aforementioned step can be utilized for transfer learning, which involves partially or fully transferring the weights to an empty computer vision neural network for fine-tuning on a primary dataset. Preferably the primary dataset is a wide/ultra-wide angle image dataset, and may be, for example, a proprietary dataset associated with the applicant. The proprietary dataset may consist of one or more images associated with one or more wide/ultra-wide angle lenses, including one or more bounding box and ground point labels linked to the images.

Preferably, the method further includes: training or fine tuning the computer vision neural network weights obtained from the previous stage with (i) one or more images associated with one or more wide/ultra-wide angle lenses from a primary dataset, the primary dataset including one or more bounding box and ground point labels associated with the one or more images (FR-T01); (j) applying a customized data augmentation routine on said images to create one or more augmented images (FR-T02); (k) resizing the one or more images to a predetermined size (FR-T03); (l) providing a predetermined neural network for computer vision model to test and train the neural network for computer vision (FR-T04); (m) predicting and obtaining a bounding box, ground point and confidence score, each being associated with one or more objects in the one or more images from the neural network for computer vision (FR-T05); (n) matching ground truth bounding boxes in the Fisheye image space to augmentations from a box data store; (FR-T06) (FR-T07); (i) apply regression loss on the bounding boxes (FR-T08); (o) matching ground truth ground points in Fisheye image space to augmentations from a ground point data store (FR-T10) (FR-T11); (i) apply regression loss on ground points (FR-T12); and (p) computing the cost between predicted values and the label values to determine change in weightings (FR-T08, FR-T09 and FR-T12). It will be appreciated that determine change in weightings may be based on based on total loss value, optimiser and learning rate scheduler states.

In an embodiment, at step (n), this step can also be carried out while images are being augmented at step (j), meaning the labels are updated according to augmentations as soon as the images are augmented.

In an embodiment, at step (o), this step can also be carried out while images are being augmented at step (j), meaning the labels are updated according to augmentations as soon as the images are augmented.

At step (n), it will be appreciated that regression loss may take any suitable form such as intersection over union (IoU) loss, gIoU (group), dIoU (distance) and the like. At step (o) it will be further appreciated that the regression loss in this step may include L1 loss, also known as Least Absolute Deviations (LAD) or Mean Absolute Error (MAE), refers to a loss function utilized in various machine learning and computer vision applications to measure the discrepancy between predicted values and actual, observed values. The L1 loss is calculated as the average of the absolute differences between the predicted values and the ground truth values across all instances in the dataset. This loss function is characterized by its robustness to outliers, as it does not square the error terms; therefore, large deviations do not disproportionately affect the overall loss as much as they would in the L2 loss (or Mean Squared Error) scenario. Consequently, the L1 loss is particularly advantageous in scenarios where it is essential to mitigate the influence of outlier values on the model's training process.

Preferably, at step (h) or step (p) the cost is computed by a cost function. The cost function may include, for example regression losses such as (cost BCE with logits loss (class, confidence). It will be appreciated that at the end of each epoch (steps FR-T13 to FR-T17), the neural network is evaluated on a validation dataset. If the evaluation results show that the neural network has achieved the best scores, its weights are stored as the ‘best checkpoint’ on the disk. If not, the training proceeds to the next epoch. At the end of the final epoch, the state of the neural network is saved as the ‘last checkpoint’ on the disk.

It will be appreciated that a person skilled in the art would recognize that a scheduler may be used to update the neural network's learning rate and optimizer state. The scheduler adjusts the rate at which the network is updated, which can have a significant impact on the model's performance. Moreover, the person skilled in the art may determine and fine-tune all training optimizer hyperparameters to enhance the model's performance.

Advantageously, the output provides a NN and inference pipeline which provides significant improvements in correct detections of objects (true positives), incorrect detections of objects (false positives), duplicate detections of objects and pixel level accurate positioning in images from a wide/ultra-wide angle lens. Advantageously, depending on the dataset, the trained NN can achieve an F1 score (a machine learning evaluation metric that measures a model's accuracy) in the order of 0.871 and an F0.5 score in the order of 0.939 which is a significant improvement over existing solutions that can be deployed on an embedded device such as FPGA and process in near real time (in the order of 2 seconds).

Preferably, at step (c), the predetermined size is 576×576 pixels. Preferably, at step (k), the predetermined size is 1152×1152 pixels.

Preferably, at step (d), the predetermined neural network for computer vision is based on one or more of depth-wise and point-wise convolutional neural network and object detection heads. The predetermined NN may be based on a MobileNetv1 backbone and YOLOv3 head. The predetermined convolutional NN is preferably a customized MobileNetv1 backbone and customized YOLOV3 heads. The customized MobileNetv1 backbone and customized YOLOv3 heads includes customizing the number of channels each convolution node has, thereby balancing accuracy and size.

Preferably, at step (b) or step (j), the one or more augmented images are augmented based on a change of parameter of the image. The parameter of the images includes one or more of hue, saturation, image rotation, scale augmentation, flip up-down augmentation, flip left-right augmentation, mosaic, contrast limited adaptive histogram equalization (CLAHE), brightness, contrast, random gamma correction, image compression, generating MJPEG image compression artefacts, channel shuffle, channel dropout, gaussian noise, motion blur, and RGB shift. A probability may be applied to the one or more parameters.

Preferably, the object recognition dataset includes one or more of MSCOCO or a publicly available image recognition dataset. Preferably, steps (a) through (h) are carried out over a first predetermined time period. The predetermined time period may be arrived at by adjustment, and may differ for each different model and dataset. For example, the first predetermined time period may be 300 epochs. In an embodiment, steps (a) to (h) are carried out over a second predetermined time period. The second predetermined time period may be 1200 epochs. It will be appreciated that a longer timeframe may be appropriate, for example 300 or 600 epochs, depending on the application. As would be appreciated by the skilled person in Machine Learning, any suitable batch size may be used. For example, based on the training server's capacity, a dataset of size 1000 may be split into 100 batches of size 10.

Preferably, at step (h) the cost is computed by a cost function. The cost function may include, for example (cost BCE with logits loss (class, confidence). The amount by which the weightings will change depends on the optimiser and learning rate scheduler state-both of which may be determined by adjustment. For example, it will be appreciated that the amount by which the weightings will change depends on a number of factors including the total loss value which is the sum of all kinds of losses (box, class and conf losses for MSCOCO dataset training, and box, gp, class, conf losses for primary dataset training) as well as the optimiser and learning rate scheduler state.

According to a second aspect, the present invention provides a method for inference of a NN model for wide/ultra-wide angle lens object detection and positioning, the method including: (a) capturing an image from the wide/ultra-wide angle lens (I01); (b) cropping the captured image around the centre of the wide/ultra-wide angle lenses field of view (I03); (c) normalising pixel values associated with the captured image (I04); (d) filling Field Programmable Gate Array Programmable Logic (PL) buffers (I05); (e) running the NN (I06); (f) predicting bounding boxes, confidences and ground points from the same neural network (I07); (g) decoding bounding boxes and ground points (I08); (h) filtering by confidence (I09); (i) determining if confidence is higher than a predetermined threshold and if higher (I10), compute box angles using arctan 2(box_centre, image_center) (I12); (j) using a ground point distance between predictions to avoid discarding far away boxes that have high area overlap (I13); (k) computing intersection over sample for pair of predictions (I14); and (l) determining if Intersection over Sample (IoS) is higher than a predetermined threshold and if below threshold (I15), output predictions for box, ground points and confidence (I17). In an embodiment, (117) further includes class, where class may include, for example “person” or “not person”. Additionally, the range of recognizable classes may include everyday items such as ‘coffee cups’ and ‘jackets’.

Preferably, the image is taken from a top-down perspective.

The captured image may be colour and converted to greyscale.

Preferably, at step (a) the image is a 1600×1200 pixel image, since it is larger than the preferred 1152×1152 size that is used in the network.

Preferably, the crop is a square crop since many of the machine learning backbones that are utilized, require square images for processing networks (but any shape could be used). The square crop may be 1152×1152 pixels.

Preferably, at step (c), the pixel values associated with the captured image are divided by 256 to normalise input data to a range between 0 and 1 (discard bits).

At step (e), the NN is a NN model for wide/ultra-wide angle lens object detection. Preferably, at step (e), the NN is the output of the method of the first aspect.

Preferably, at step (i) (I10) if below predetermined threshold, discard prediction. Preferably, at step (l) (I15) if IoS is higher than a predetermined threshold, discard prediction with lower confidence.

According to a third aspect, the present invention provides a system including: one or more processors; and memory, communicatively coupled to the one or more processors, for storing: a NN training module for training of a NN model for wide/ultra-wide angle lens object detection and positioning, the NN training module configured to: a) receive one or more images associated with one or more images from the object recognition data set, the data set including one or more bounding box labels associated with the one or more images (R-T01); b) apply a customized data augmentation routine on said images to create one or more augmented images in each new iteration of training (R-T02); c) resize the one or more images to a predetermined size; (R-T03); d) provide a predetermined neural network for computer vision model to test and train the neural network for computer vision (R-T04); e) predict and obtain a bounding box and confidence score, each being associated with one or more objects in the one or more images from the neural network for computer vision (RT-05); f) match ground truth bounding boxes in image space to augmentations from a box data store (R-T06) (R-T07); g) apply regression loss on the bounding boxes (R-T08); h) compute the cost between predicted values and the label values to determine change in weightings (R-T09). At step (g), it will be appreciated that regression loss may take any suitable form such as intersection over union (IoU) loss, gIoU (group), dIoU (distance) and the like.

According to a fourth aspect, the present invention provides a system including: one or more processors; and memory, communicatively coupled to the one or more processors, for storing: a NN inference module for inference of a NN model for wide/ultra-wide angle lens object and positioning, the NN inference module configured to: a) capture an image from the wide/ultra-wide angle lens (I01); b) crop the captured image around the centre of the wide/ultra-wide angle lens (I03); c) normalise pixel values associated with the captured image (I04); d) fill Field Programmable Gate Array Programmable Logic (PL) buffers (I05); e) run the NN (I06); f) predict bounding boxes, confidences and ground points (I07); g) decode bounding boxes and ground points (I08); h) filter by confidence (I09); i) determine if confidence is higher than a predetermined threshold and if higher (I10), compute box angles using arctan 2(box_centre, image_center) (I12); j) use a ground point distance between predictions to avoid discarding far away boxes that have high area overlap (I13); k) compute intersection over sample for pair of predictions (I14); and l) determine if Intersection over Sample (IoS) is higher than a predetermined threshold and if below threshold (I15), output predictions for box, ground points and confidence (I17). In an embodiment, (117) further includes class, where class may include, for example “person” or “not person”. In a further embodiment, at step (f) prediction of bounding boxes, confidences and ground points may be from the same final convolution layer.

### BRIEF DESCRIPTION OF DRAWINGS

The invention will now be described in further detail by reference to the accompanying drawings. It is to be understood that the particularity of the drawings does not supersede the generality of the preceding description of the invention.

FIG. 1A is a flow diagram of a method of training a NN model on a publicly available object recognition dataset for wide/ultra-wide angle lens object detection and positioning that can be utilized to give effect to the method and system of the present invention through transfer learning;

FIG. 1B is a flow diagram of a method of training a NN model on a primary dataset for wide/ultra-wide angle lens object detection and positioning that can be utilized to give effect to the method and system of the present invention;

FIG. 2 is an example annotated image primary dataset which may be utilized with the method and system of the present invention;

FIGS. 3a and 3b are example images showing a “person” class annotations which may be utilized with the method and system of the present invention;

FIG. 4 is an example image for input a NN model which may be utilized with the method and system of the present invention;

FIG. 5a is an example image of a sample prediction;

FIGS. 5b and 5c are example images where non visible ground points are managed;

FIGS. 6a and 6b are example images showing augmentation scheme outputs; and

FIG. 7 is a flow diagram illustrating a method for inference of a NN model for wide/ultra-wide angle lens object and positioning on a low powered edge device such as FPGA that can be utilized to give effect to the method and system of the present invention.

### DETAILED DESCRIPTION

The present invention will be described from the point of view of a standalone platform, but equally may be provided in the form of a white label platform that is provided to organisations and individuals or may be integrated with third party platforms to connect with the system (e.g., an API to a third party application).

It will be appreciated that any lens may be utilized with the system and method of the present invention. In the context of a floor plan in a room for example, camera angle coverage is generally proportional to the camera installation height (such as in a ceiling). It is desirable to be able to see enough of the scene to cover a wide area, but still see enough detail to identify people.

Depending on the application, the sensor may have a smaller range in which it can detect objects. The network training would simply be re-worked, with the same system and method of the present invention. However, in the context of a floor plan, working with a large area generally requires a wider angle lens.

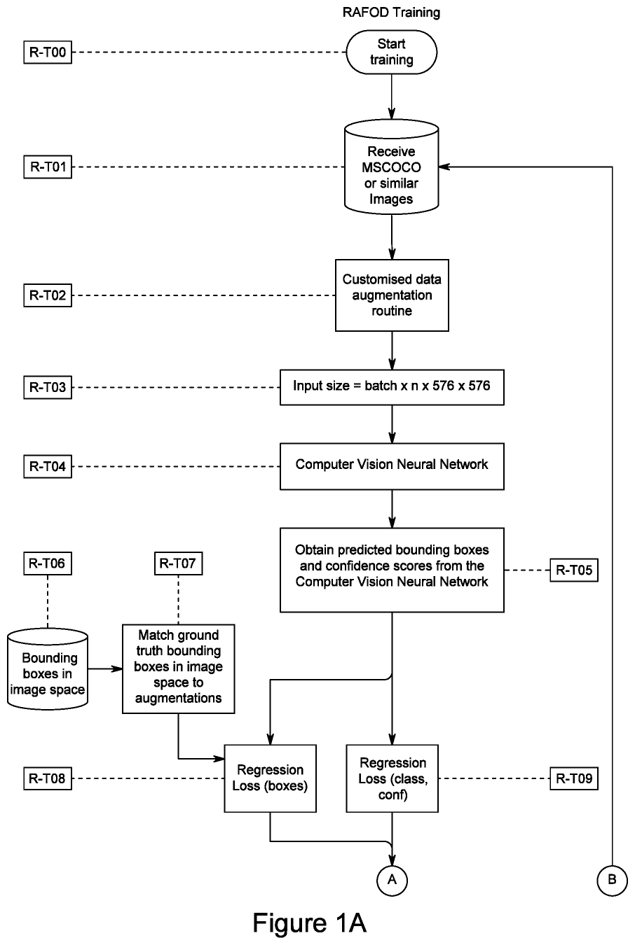

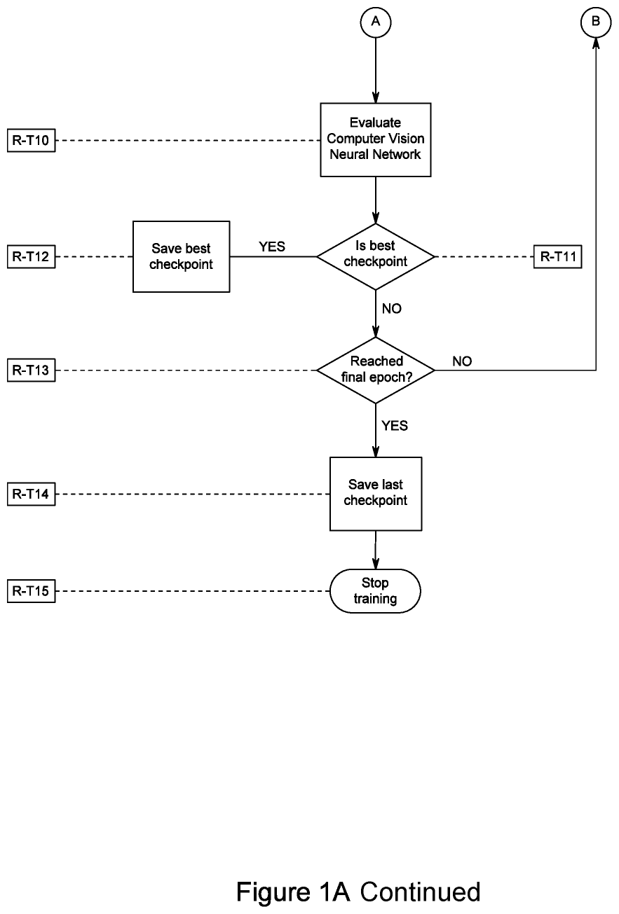

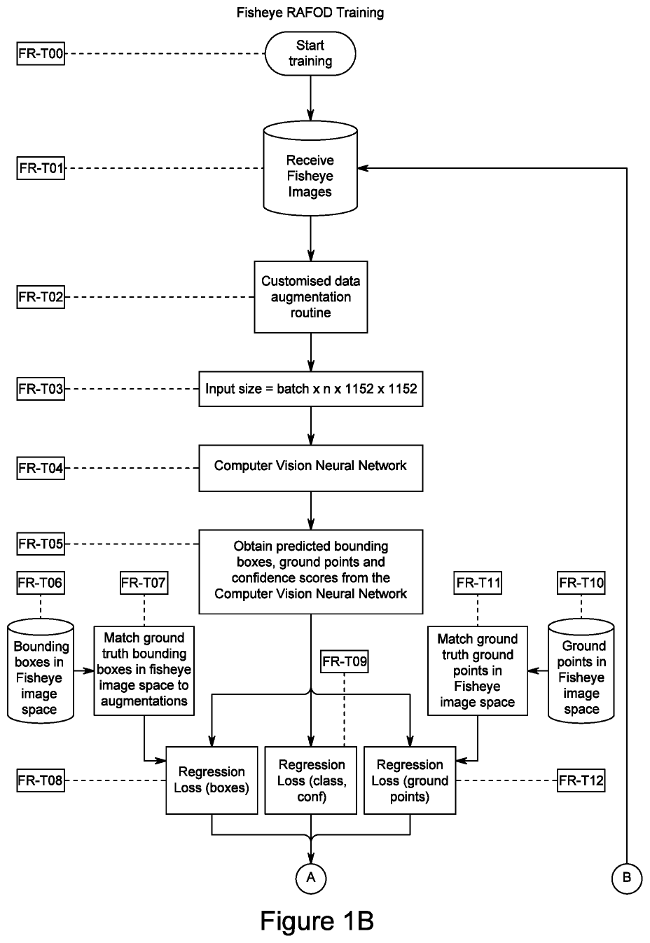

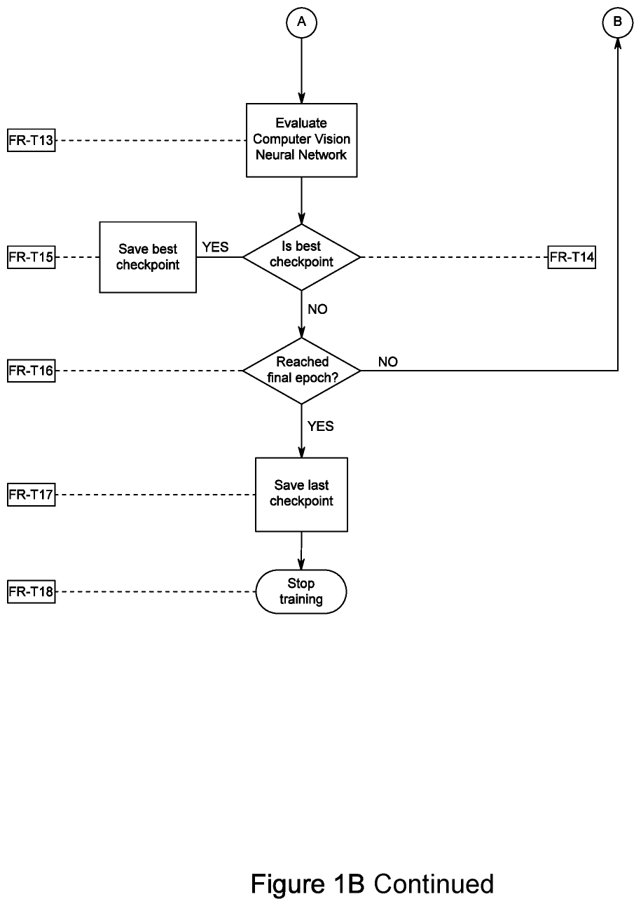

FIG. 1A is a flow diagram 100 of a method of training a NN model for ‘n’ iterations on a publicly available object recognition dataset such as MSCOCO for wide/ultra-wide-angle lens object detection. The method may be carried out on any suitable device but in the preferred embodiment it may be trained on servers adapted for computation such as servers featuring GPU's. The training output can be employed for transfer learning to train the subsequent stage on a primary dataset. The weights may be partially or fully transferred for the subsequent stage.

It is to be understood that a person skilled in the art may select the hyperparameters of the training optimizer through adjustment and choose an appropriate batch size to divide the dataset into ‘n’ iterations based on the memory bandwidth of the GPU server. Additionally, an appropriate learning rate scheduler may be employed, which can be configured through adjustment.

At step R-T01 one or more images associated with a publicly available object recognition dataset are received, the dataset including one or more bounding box labels associated with the one or more images.

At step R-T02 a customized data augmentation routine is applied on said images to create one or more augmented images. At step R-T03 the one or more images are resized to a predetermined size. At step R-T04 a predetermined neural network for computer vision model is provided to test and train the neural network for computer vision. At step R-T05, bounding box and confidence score is predicted and obtained, each being associated with one or more objects in the one or more images from the neural network for computer vision. At step R-T07, matching of ground truth bounding boxes in image space is carried out to augmentations from a box data store (R-T06). Specifically, at step R-T07, the ground truth bounding box locations provided in R-T06 are modified to match any image warping that may have occurred as a part of the augmentation process at R-T02, so that the bounding box locations correctly correspond to objects in the augmented image. The data store is the original ground truth data associated with the images. The ground truth bounding boxes specify locations of a box in an image. Augmentations that are applied to an image before it is input into the NN can change the size/shape/location of the parts of the image that the boxes are around. Spatial changes may be applied on the bounding boxes (which are in the locations in the original image) so that they move to be over the same object in the augmented image. In an embodiment, Step R-T07 may be carried out at step R-T02 along side image augmentation.

A regression loss such as an intersection over union (IoU) loss is applied on the bounding boxes at step R-T08 before the cost between predicted values and the label values is computed to determine change in weightings at step R-T09. The loss computation is executed, and the neural network weights are updated based on the total loss value, as well as the states of the optimizer and the learning rate scheduler.

At the conclusion of each epoch, which involves an iteration over the entire dataset divided into ‘n’ batches, the neural network is evaluated at step R-T10 on a validation dataset. If the evaluation results at step R-T10 show that the neural network has attained the highest scores, its weights are saved to disk at step R-T12 as the “best checkpoint.” If the scores are not the best, training continues to the next epoch.

At step R-T13 the method determines whether or not the method has been running for a predetermined time period which may be measured, for example, in epochs. Steps R-T00 through R-T15 may be carried out over a first predetermined time period which, may, for example, be 300. There could be several iterations of the R-T00 through R-T15 steps until the optimal weights for transfer learning are attained.

At step R-T13, in the event that the final epoch is reached, the state of the neural network is saved as the ‘last checkpoint’ on the disk (R-T14). The method ends at step R-T15.

The output of the training stage described above can be used for transfer learning to fine-tune a subsequent stage on a primary dataset. The weights may be fully or partially transferred to the next stage. Alternatively, it should be noted that a skilled person in the art who has access to a large wide/ultra-wide angle fisheye image dataset with all necessary labels may choose to skip the previous stage entirely.

FIG. 1B is a flow diagram 200 of a method of training a NN model on a primary dataset for wide/ultra-wide-angle lens object detection and positioning. The method may be carried out on any suitable device but in the preferred embodiment it may be trained on servers adapted for computation such as servers featuring GPU's. The output of the training then may be provided and used on a FPGA device.

It is to be understood that a person skilled in the art may select the hyperparameters of the training optimizer through adjustment and choose an appropriate batch size to divide the dataset into ‘n’ iterations based on the memory bandwidth of the GPU server. Additionally, an appropriate learning rate scheduler may be employed, which can be configured through adjustment. The skilled person may also choose to freeze some of the neural network weights and only optimize a part of the neural network.

The method starts at step FR-T00 before moving to step FR-T01 where one or more images associated with one or more ultra-wide-angle lenses are received from a primary dataset. The primary dataset includes one or more bounding box and ground point labels which are associated with the one or more images in the primary dataset. The primary dataset may take any form, for example a commercially available data set that has within it bounding box and ground point labels associated with the images. New data sets may also be utilized provided they have the necessary ground point labels and bounding boxes associated with the images within the data set. Alternatively, the data set may be a proprietary data set such as that developed by the applicant.

The next step in the method is FR-T02 where a customized data augmentation routine is carried out on the images to create one or more augmented images. The data augmentation is a way of expanding the primary data set which avoids the need, for example, to have an image data set that is extremely large. In practice, having an extremely large data set, while useful, is extremely expensive since it typically requires a human to identify bounding boxes and ground points manually for provision into the data set. Advantageously by applying a customized data augmentation routine, this creates more images for the data set.

Preferably the augmented images are augmented based on a change of parameter of the image. This can take any form and be in any combination but, for example, the parameters of the images include one or more of hue, saturation, image rotation, scale augmentation, flip up-down augmentation, flip left-right augmentation, mosaic, contrast limited adaptive histogram equalisation (CLAHE), brightness, contrast, random gamma correction, image compression, generating MJPEG image compression artifacts, channel shuffle, channel dropout, gaussian noise, motion blur, and RGB shift. Further, a probability may be applied to one or more parameters.

For example, an augmentation scheme may include the following augmentations with corresponding probabilities expressed as percentages in brackets:
Hue, Saturation, Value augmentation (30%):
   a. Image Hue: 0.015
   b. Image Saturation: 0.7
   c. Image Value: 0.4
Image rotation augmentation (100%): Randomly rotate input image by +/−180 degrees.
Scale augmentation (100%): Randomly up/down scale input image by a factor of 0.7.
Flip up-down augmentation (50%): randomly flip every second image up-down.
Flip left-right augmentation (50%): randomly flip every second image left-right.
Mosaic (100%): Create a mosaic of 4 images before input to training.
CLAHE (1%): Randomly apply CLAHE.
Brightness/Contrast with brightness limit (−0.2, 0.5) since offices are generally “bright” environments (50%).
Random Gamma (10%): Randomly vary the image contrast and brightness via gamma correction.
Image Compression (20%): Generate MJPEG image compression artefacts in the image.
Channel Shuffle (30%): Randomly shuffle BGR channels before converting to grayscale.
Channel Dropout (1%): Randomly drop out a BGR channel.
Gaussian Noise (2%): Randomly add gaussian noise.
Motion Blur (30%): Randomly apply motion blur effect.
RGB Shift (10%): Randomly generate lighting noise.

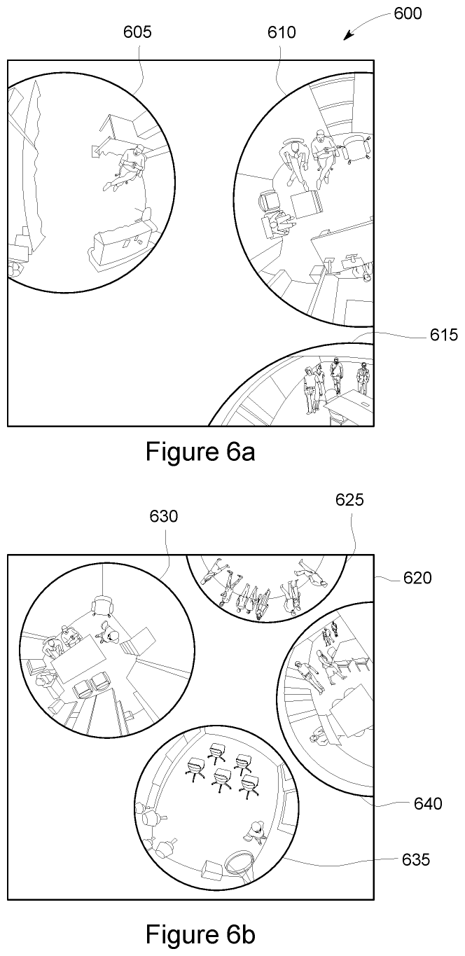

Advantageously, by incorporating these augmentations during training, the NN model performance is improved and its ability to generalise to new images is increased. It will be appreciated that a number of combinations or percentages may be applied. Two examples are shown in FIGS. 6a and 6b of what input images look like after the application of the above augmentation scheme (followed by conversion to grayscale input if required and depending on the implementation).

Advantageously, the network is taught to recognise object width and height upon rotation, by simply using the original width and height labels of the object even after rotating the image. Alternatively, it is possible to modify the object's width and height labels so as to tightly fit the rotated object in the rotated image, or to include the additional angle parameter in the labels. The NN and training flow may be adapted to incorporate the modifications described above. This may involve changes to the NN architecture, hyperparameters, or training data, as well as modifications to the loss function or optimization strategy. The resulting NN model and training process may be optimized to achieve the desired performance and accuracy. Inference may also be modified according to the new specifications. It will be appreciated that with any new modifications to the labels, such as changing the bounding box definition to include an angle parameter or the like, the NN model and training flow will have to be reworked as appropriate.

At step FR-T03, the one or more images are resized to a predetermined size. Preferably, the image is resized to a size which matches the images which will be utilized for the implementation. Preferably the input size is an image size that is appropriate relative to the training data for example. In an embodiment, the predetermined size is, for example, 1152×1152 pixels.

At step FR-T04, a predetermined computer vision neural network model is provided. The predetermined NN is preferably based on one or more of depth-wise and point-wise convolutional NN's and convolutional object detection heads. In an embodiment, the predetermined NN is based on a MobileNetv1 backbone and YOLOv3 head.

Preferably, the predetermined convolutional NN is a customized MobileNetv1 backbone and customized YOLOv3 heads. The customization on the YOLOv3 heads includes, for example, customizing the depth of the convolutional NN and the number of channels each convolution node has which thereby provides a balance between accuracy and size.

At step FR-T05 bounding box, ground point and confidence score, are obtained—each being associated with one or more objects in the one or more images from the neural network (FR-T05). It will be appreciated that for multi-class CNN, class scores are also predicted. It will be further appreciated that ground points, confidences and bounding boxes are outputs that are collected, but don't necessarily come from the same node in a network, and also don't necessarily come from a convolution node.

At step FR-T07, matching of ground truth bounding boxes in image space is carried out to augmentations from a box data store (FR-T06). The data store is the original ground truth data associated with the images. Specifically, at step FR-T07, the ground truth bounding box locations provided in FR-T06 are modified to match any image warping that may have occurred as a part of the augmentation process at FR-T02, so that the bounding box locations correctly correspond to objects in the augmented image. The results of the NN at that point in the training are compared against the “ground truth” which is the manually derived location of the bounding box and ground points so as to provide a measure of the area of box overlap divided by the area of the box non-overlap. In an embodiment, Step FR-T06 and FR-T07 may be carried out at step FR-T02 along side image augmentation.

At FR-T08 an intersection over union (IoU) loss is applied on the bounding boxes.

At step FR-T11 matching of ground points in Fisheye image space is carried out to augmentations from a ground point data store (FR-T10). The results of the NN at that point in the training are compared against the ground truth ground points which are manually derived real locations of the ground points and then at step FR-T12 a smooth L1 loss is applied to the ground points. In an embodiment, Step FR-T10 may be carried out at step FR-T02 along side image augmentation.

At step FR-T09, the cost between predicted values and the label values may be computed to determine change in weightings. Preferably this involves a cost function, for example cost BCE with logits loss (class, confidence). This step computes the cost between predicted values and the label values to then determine how the weights need to change in the NN to be able to make correct predictions. All cost/loss computations are executed, and the neural network weights are updated based on the states of the optimizer and the learning rate scheduler. It will be appreciated that determine change in weightings may be based on based on total loss value, optimiser and learning rate scheduler states.

At the conclusion of each epoch, which involves an iteration over the entire dataset divided into ‘n’ batches, the neural network is evaluated on a validation dataset at step FR-T13. If the evaluation results show that the neural network has attained the highest scores, its weights are saved to disk FR-T15 as the “best checkpoint” at step FR-T14. If the scores are not the best, training continues to the next epoch.

At step FR-T16 the method determines whether or not the method has been running for a predetermined time period which may be measured, for example, in epochs. Steps FR-T00 through FR-T16 may be carried out over a first predetermined time period which, may, for example, be 300 or 600 epochs.

At step FR-T16, in the event that the final epoch is reached, the state of the neural network is saved as the ‘last checkpoint’ on the disk (FR-T17). The method ends at step FR-T18.

The present invention, in addition to utilizing the primary dataset, preferably utilizes an object recognition dataset in some of the initial ‘n’ iterations of NN training stages as described above with reference to FIG. 1A. This combination allows for tuning of the network and results in an increase in accuracy, particularly in the “direct top-down region”—that is, the area of the wide/ultra-wide angle image directly beneath the camera (that only captures a persons head and shoulders for example) reducing inaccuracies and missed detections for objects that appear directly below a camera (i.e. direct top-down objects).

Advantageously, training in combination with the primary data set provides the NN with sufficient context to correctly estimate the appearance of direct top-down objects, along with their ground point labels. This is because direct top-down objects are located very close to the centre of the wide/ultra-wide angle lens image and have distinct features compared to other areas of the image. As a result, the NN's convolution filters adapt in such a way that it becomes easier for it to recognize the differences and can accurately detect direct top-down objects.

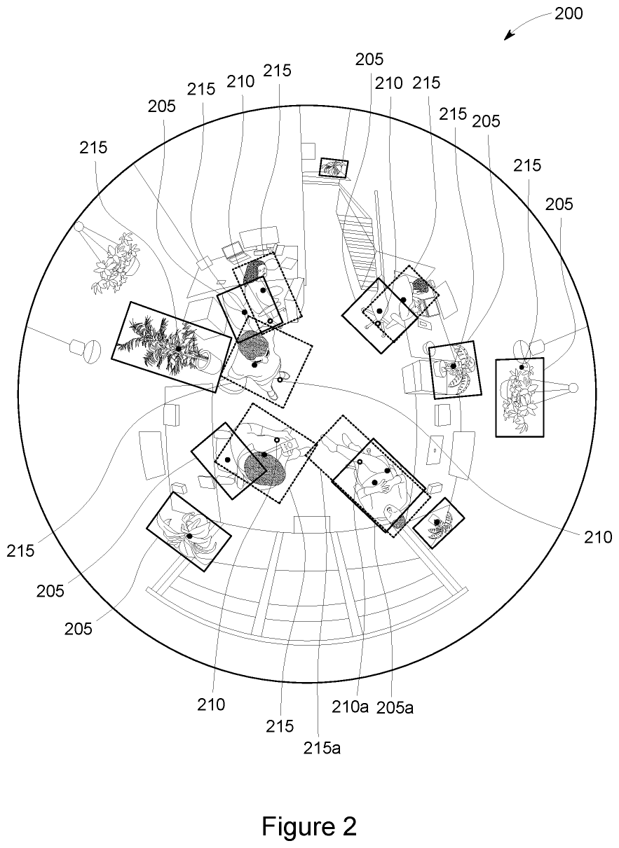

FIG. 2 is an example annotated image which may be utilized with the method and system of the present invention, and in particular is an example of the primary dataset (which is the applicant's proprietary dataset) which may be utilized at step (a) with reference to FIG. 1B. It will be appreciated that the applicant's proprietary dataset need not be utilized and any suitable dataset may be used.

Image 200 is annotated within the dataset such that the image 200 has a number of annotations 205, 210, and 215. Each of the annotations 205, 210 and 215 assist with determining objects (and in the present case, “person” class objects). However, it will be appreciated that the present invention is not limited to that use. Annotation 205 is a bounding box, which is associated with labels which may include additional objects that have been labelled, in this image for example, “chair” and “plant” classes have been labelled in addition to a “person” class object. This can be used to illustrate that the present invention can also label and thereby train a NN to predict other objects than “person” class. Annotation 210 indicates an object (in this case a person) and their ground point location. The ground point location is defined as a key point which represents a projection of the centre of mass of the object on the floor (again, in this case the object may be for example a person) as shown in FIG. 2. An alternative configuration can be created by changing the definition of ground point to ground region or a similar term, which would represent a small area under the object around the ground point. Each of the annotations 210 are associated with a dot and corresponds to an annotated ground point. Annotation 215 is to associate annotated objects (in this case, people).

Taking one “person” as an example, in the image 200 of FIG. 2, annotation 205A represents a bounding box for the person sitting in the chair with their hands clasped. Annotation 215a which is the annotated object (in this case a person) who is sitting in a chair with their hands clasped (for ease of reference). Also provided is annotation 210A which is an annotated ground point which represents the projection of the person's centre of mass onto the floor. It will be appreciated that instead of the bounding box annotations described above (which may be considered to be “2-dimensional), 3-dimensional bounding box annotations may be used. In this case, the centre point of the bottom surface of a 3-dimensional box can be used to approximate the ground point label.

Image 200 in FIG. 2 is taken from, for example a wide/ultra-wide-angle lens which, may be for example a fisheye lens, associated with some hardware that may be provided within a space where details of the occupancy is required. As would be appreciated by the skilled person any suitable hardware may be used. For example, an FPGA (such as a Xilinx FPGA) using a camera module (for example a Sony IMX179 image sensor). For training data, some images come from other sources, but the exact nature of the hardware that it is taken on is unknown. The neural networks may be trained on images captured by various cameras, in order to make them independent of the source camera hardware. Both training and inference can be performed on images from any camera hardware, as long as it captures images with the specified field of view, which is determined by factors such as the camera's installation height and angle of view.

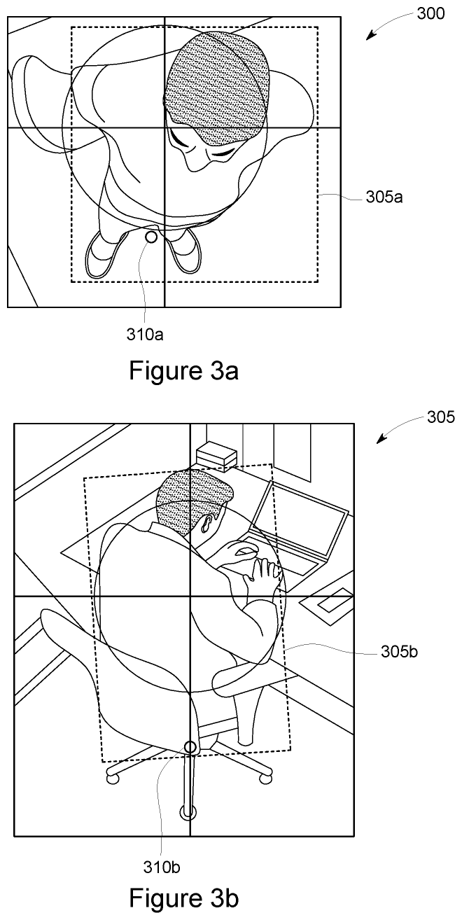

FIGS. 3a and 3b are example images showing “person” class annotations which may be utilized with the method and system of the present invention. FIG. 3a is an example of an image 300 taken from the image 200 of FIG. 2 which illustrates an example of an object class annotation (in this case a “person” class annotation). The image 300 is annotated with annotation 205 which denotes a bounding box. In the context of object detection, the bounding box refers to a substantially rectangular box that is drawn around an object of interest in an image. The purpose of a bounding box is to locate and identify the object location within the larger image or scene. A bounding box is defined by its four corner points, which may be denoted in any number of ways such as: (x_min, y_min) and (x_max, y_max), where (x_min, y_min) represents the coordinates of the upper-left corner of the box, and (x_max, y_max) represents the coordinates of the lower-right corner of the box. The width of the bounding box is given by x_max-−x_min, and the height is given by y_max-−y_min. Another way to define the bounding box is (xc, yc, width, height) where (xc, yc) is the object's center point and (width, height) are the object's dimension. Alternatively, it may be defined by its 4 vertices in an image space: ((x1, y1), (x2, y2), (x3, y3), (x4, y4)) for example.

FIG. 3b is a further example of an image 305 which includes an annotation 305b being a bounding box and a further annotation 310b which is an annotated ground point. The ground point corresponds to the object's centre of mass projected onto the floor forming a pixel level accurate positioning in the image.

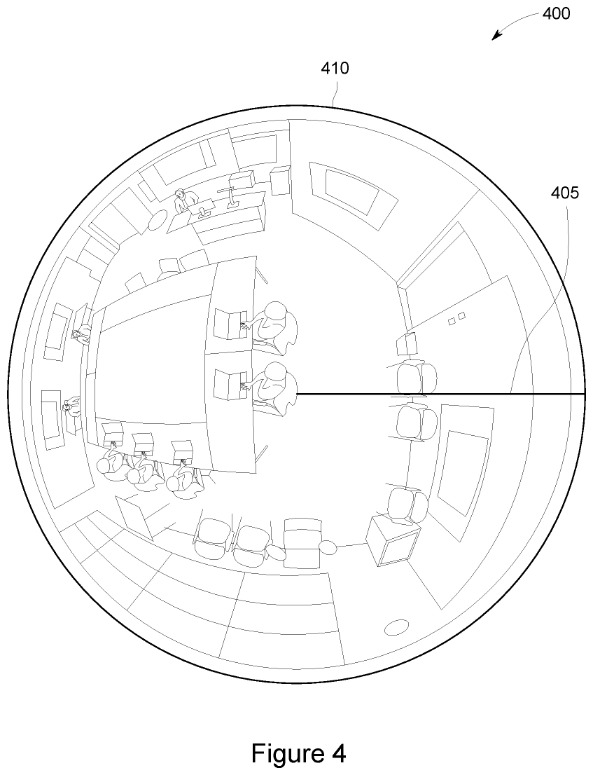

FIG. 4 illustrates an image 400 which is provided as input to the NN model, in this case, may be a grayscale image which may take the dimensions of 1152×1152 pixels. It will be appreciated that a colour image may alternatively be used. This may be, for example, an image from a fisheye or a wide/ultra-wide-angle lens. The system identifies a fisheye circle which is denoted 410 together with a radius 405. In a preferred embodiment, the NN model is trained with an image capture resolution of 1600×1200 in mind which will produce a central “square” of dimensions 1152×1152 which encloses the fisheye circle. The NN may be trained on single-channel greyscale images in each step of the curriculum since that is an advantageous way to process the image in the existing configuration of the target embedded device, but equally may be trained on colour images. Depending on requirements and complexity of the network that operates on those images, greyscale or colour images may be used. Since colour images are larger and more complex than greyscale this can affect both speed and power use, and also heat generation, which can then be managed if required.

The NN model is dependent on the “radius” of what is denoted as the fisheye circle. The input image, and all associated boxes and points, are scaled in such a way that the boxes and points correctly line up with features in the image when the image is scaled to a default input image dimension (which may be, for example 1152×1152 pixels). This scaling also allows transformations to take place that take into account the central point of the fisheye image (the center of the image circle) not being necessarily in the center of the input image.

The training pipeline assumes that all objects in the image 400, for example are aligned to the radius 405 and therefore, any default boxes for object detection heads are configured according to the radius length of 576, rather than the image dimensions of 1152 in contrast existing yolo NN techniques tend to use default boxes which are configured according to the input dimensions. In the present invention all default boxes are configured based on a fisheye circle radius of 576 rather than standard practice of configuring default boxes based on input image dimensions. The radius of 576 is derived from the input size of 1152. Generally, the radius is the input size divided by 2. Given that the NN learns detecting objects aligned to the radius, the default boxes configured for training are tuned according to the radius size, rather than turning them according to an input image size.

If default boxes are required, they may be pre-defined bounding boxes of different aspect ratios and scales that may be placed at specific locations in the input image. Default boxes may be utilised in object detection to provide a set of reference boxes that the system and method can use to predict the location and size of the objects of interest. It will be appreciated that default boxes may be configured by other means as well, for example, by looking at the distribution of all box label dimensions. Alternatively, if the computer vision/NN doesn't require the defining of default boxes, they may be skipped altogether depending on the NN in use.

The NN is trained to learn an object's ground point location. Bounding boxes are regressed, and may be regressed in any suitable manner as would be appreciated by a person skilled in the art.

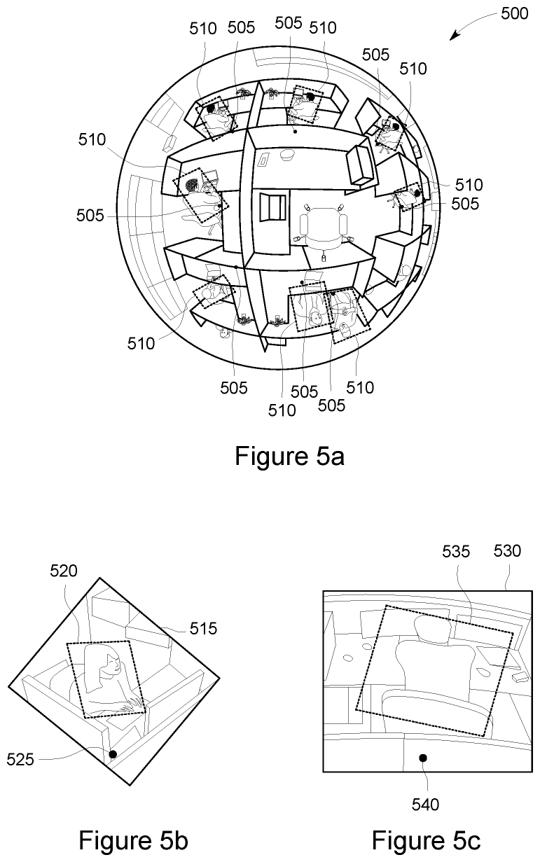

During the NN training, bounding boxes and ground points are regressed against ground truth locations of bounding boxes and ground points respectively. As will be appreciated by those skilled in the art, this may be done in any other suitable way, for example an image grid for regressing ground points need not be used. Instead, Vision Transformers (which are a different type of NN) may be trained to directly regress the coordinates of each keypoint (which equates to a ground point in the present invention), typically in the form of (x, y) pixel locations. Advantageously, ground point prediction is completely independent of bounding box prediction and unconstrained, as estimating the ground point location is not always feasible or visible. FIGS. 5a, 5b and 5c are visualisations of predictions. It will be appreciated that bounding box training may be carried out in any suitable manner known in the art. In the present invention, ground point prediction is independent of the bounding box training. For example, in YOLO object detection framework, the image is divided into a grid of cells, and each cell predicts a fixed number of bounding boxes (default boxes) that are regressed against the ground truth boxes during training. The default boxes are predefined shapes and sizes that are chosen to cover a wide range of object sizes and aspect ratios. During inference, the predicted bounding boxes are offset from these default boxes based on the grid cell that they belong to, and then adjusted to the correct scale and aspect ratio.

The ground points are regressed against labels using a custom formula:

$${gp}_{x} = {tgp}_{x} + {c}_{x}$$

$${gp}_{y} = {tgp}_{y} + {c}_{y}$$

where: gpₓ, gp_{y}: Final ground point predictions, after computing offset from grid cells; and: tgpₓ, tgp_{y}: Ground point co-ordinates output from the neural network, which are offset by corresponding grid cell co-ordinates cx and cy.

Advantageously, incorporating ground point labels provide the NN with additional information on the features of objects, which in turn improves prediction accuracy. By combining bounding box and ground point information in the wide/ultra-wide angle lens, the resulting labels are more informative than using only bounding box labels, as illustrated in FIG. 5a. The final model can identify ground point locations regardless of the object's orientation along the radius of the wide/ultra-wide angle lens.

As described above, FIGS. 5a, 5b and 5c illustrate sample predictions according to the system and method of the present invention and in particular where the supposed “floor” ground point is not visible (for example, where a desk is in the way or some other object). Advantageously, the present invention can approximate the ground point prediction with some accuracy.

Shown in FIG. 5a is an image 500 from a wide/ultra-wide-angle lens in a fisheye format which includes a number of annotations and in particular predicted bounding boxes 510 and predicted ground points 505. As can be seen, the predicted bounding boxes 510 accurately identify one or more target objects which in this case is “people”. Further, as can be seen from FIG. 5a, the annotations 505 which are associated with predicted ground points are also accurate. By incorporating ground point labels this provides the NN with additional information on the features of objects (in this “people”), which in turn improves prediction accuracy. The bounding box and ground point information are combined in the fisheye space and the resulting labels are more informative than using only bounding box labels. Advantageously the final NN model can identify ground point locations regardless of the orientation of the object along the radius of the fisheye circle.

FIG. 5b shows in detail an annotation for a predicted bounding box 520 for a person sitting at a desk where they are obfuscated by their desk and some monitors. The predicted ground point 525 is also obfuscated by the desks. Similarly in FIG. 5c image 530 indicates a predicted bounding box 535 for an object (i.e. a person) who is sitting away from the camera and also provides the predicted ground point which is obfuscated by a partition of a desk.

FIGS. 6a and 6b are example images showing augmentation scheme outputs. FIG. 6a illustrates an example of the augmentation scheme output showing an image 600 which with augmented images 605, 610, 615. Each individual fisheye image in this mosaic is augmented before arranging them in a 2×2 mosaic. A batch of these mosaic images forms input to a NN at the training stage, so as to feed the NN very difficult images at the training stage, whereas at inference it will only see a simple fisheye image. It will be appreciated that in the case of colour images, the final augmented image need not be converted to grayscale. It will be appreciated that training and inference can work on both grayscale as well as colour images.

FIG. 6b shows an augmentation scheme output in the form of an image 620 with augmented images 625, 630, 635 and 640.

It will be appreciated by the skilled person that the output of training (NN output from the flowchart of FIG. 1B) in the system and method of the present invention may be compressed using the techniques of quantisation and/or pruning to reduce the size of the neural network model, where that quantised/pruned/compressed version is converted to be of an optimal size for use in an FPGA or similar low power embedded devices. It will further be appreciated by the skilled person that a further step may be carried out where the model is converted into VHDL for use on the FPGA.

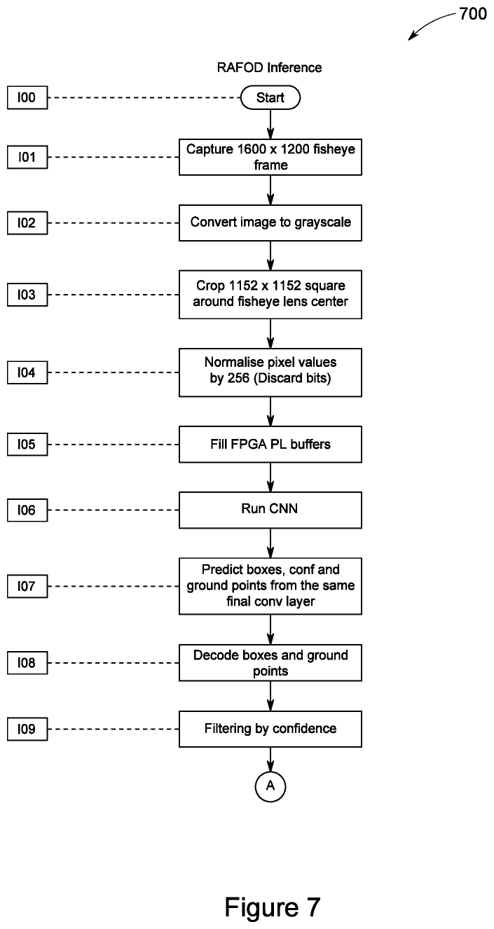

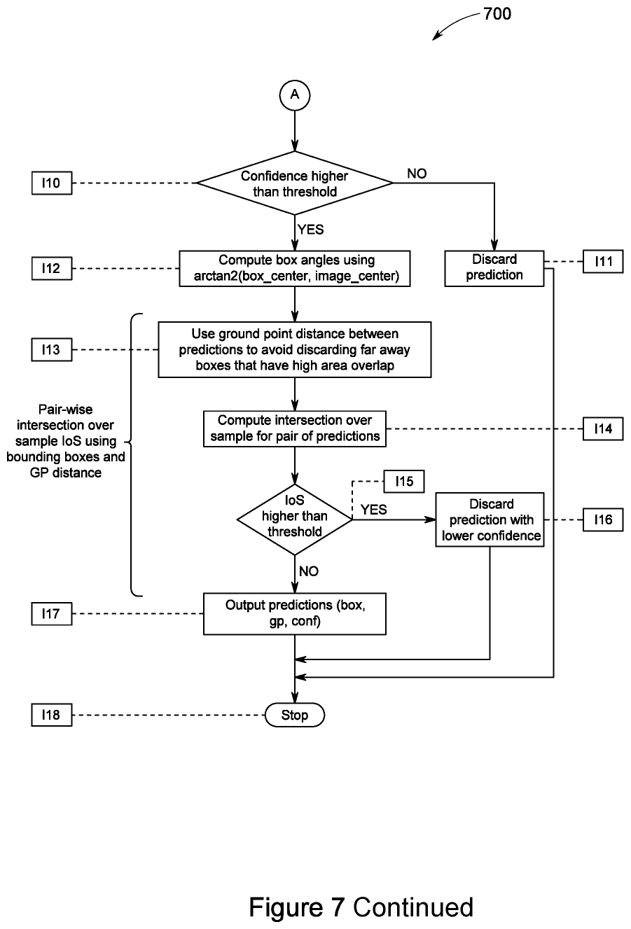

FIG. 7 is a flow diagram illustrating a method 700 for inference for a NN model for wide/ultra-wide-angle lens object and positioning that can be utilized to give effect to the method and system of the present invention. It will be appreciated that inference occurs on the device itself. Preferably, processing devices could include for example, Field Programmable Gate Arrays (FPGA), Tensor processing units (TPU), edge TPU, low powered microprocessors (e.g. ARM), Neuromorphic processors and the like. In combination with the training method and dataset with ground points and ground boxes allows for an improved implementation on the device.

The method starts at step 100 and at step 101 an image is captured from the wide/ultra-wide angle lens which may be associated, for example with a hardware device such as a FPGA-based SOC (system on chip) with ARM processors (a non limiting example of hardware might include for example an AMD/Xilinx Zynq 7000 series device). Preferably the image that is captured is a 1600×1200 pixel image but it will be appreciated that any size image may be appropriate depending on the lens used for example or the requirements of what is being captured.

Preferably, the image is captured from a top down perspective since a top down view will have less obstructions and provide a clearer view of a larger area and a larger line of sight. Further, with regard to datasets, perspective data is easy to obtain, so in an embodiment, the system may be optimised for top down. Provided there is a reasonably sized data set, the system and method of the present invention could equally be used to work with perspective data and a perspective implementation.

At step 102 the captured image may optionally be converted to greyscale such as that shown in FIG. 4. However, for the reasons described above, this step may be omitted if a colour image is to be used.

At step 103 the captured image from step 102 is cropped around the centre of the wide/ultra-wide-angle lens. Preferably the crop is substantially square around the centre of the wide/ultra-wide-angle lens. In a preferred embodiment the crop is 1152×1152 pixels. The cropping around the centre is not just the centre of the captured image, the lens/camera calibration also has to be taken into account to make sure the centre of the cropped image is pointing straight down. Otherwise, the detected locations may be incorrect. Fisheye lens camera calibration may be carried out in any number of ways as a person skilled in the art would appreciate. One technique is fisheye distortion correction which involves capturing a set of calibration images of a known pattern (such as a checkerboard), analyzing them to determine intrinsic and extrinsic parameters, and applying a fisheye lens model to correct the distortion. Another approach may include finding where the lens center is in the image by surrounding the lens with a plastic dome, lighting up the dome, and then obtaining a white image which should be completely circular. The center of that circle is then the center of the lens.

At step 104, pixel values associated with the captured image are normalised. In particular the normalisation may be 256 (discard bits). The present invention normalises input pixels using a value of 256 instead of the standard practice of 255. This impacts processing on the FPGA because normalisation can simply be done by discarding bits rather than dividing each pixel value by 255 which allows for faster computation on the embedded device, enabling real-time processing. By increasing the normalisation value, the present invention is able to effectively reduce the computational complexity of the network, while maintaining the accuracy of the predictions.

Dividing by 255 is a typical normalization technique to scale pixel values between 0 and 1, which is useful for training neural networks. However, dividing by 255 requires a more complex division operation, which can be more computationally expensive on embedded devices such as ARM CPUs. By normalizing by 256 instead, the present invention takes advantage of the fact that 256 is a power of 2, which means that the present invention can discard the least significant bit in the binary representation of the pixel value. This simplifies the computation and reduces the processing time on embedded devices. Additionally, since most image sensors have a bit-depth of 8 bits per channel, normalizing by 256 still results in pixel values that are very close to the 0 to 1 range used in traditional normalization.

At step I05 the field programmable gate array logic buffers are filled before the NN is run at I06. At I07 bounding boxes, confidences and ground points are predicted. This may be, for example, by any suitable way including, for example, from the same final convolution layer.

At step I08 bounding boxes and ground points are decoded.

At step I09 filtering is carried out by confidence.

At step I10 it is determined whether or not confidence is higher than a predetermined threshold. The threshold for the system and method of the present invention utilising grayscale is 0.5 and 0.55 when utilising colour. The threshold is determined by running the NN on the primary dataset and finding which confidence threshold gives the best balance between detected true positives and false positives. If higher, then control moves to step I12 where box angles are computed using, for example, arctan 2(box_centre, image_centre). In an embodiment, the primary dataset at this step may include a test subset of the primary dataset, where the test subset is a subset of images which are only used for testing.

At I13 a ground point distance is used between predictions to avoid discarding far away boxes that have high area overlap. In the event the confidence is lower than the predetermined threshold then control moves to step I11 where the prediction is discarded.

At step I14 the method computes the intersection over a sample for a pair of predictions. At step I15 it's determined whether Intersection over Sample (IoS) is higher than a predetermined threshold and in the event that it is below the threshold, control moves to step I17 where output predictions are provided for box, ground points, and confidence. It will be appreciated that this may further include class, where class may include, for example “person” or “not person”. Additionally, the range of recognizable classes may include everyday items such as ‘coffee cups’ and ‘jackets’.

Otherwise, if the IoS is higher than the predetermined threshold, control moves to step I16 where the prediction is discarded with lower confidence.

The method finishes at step I18.

Steps I14 to I17 advantageously takes a different approach than standard post processing approaches (a standard approach for non-maximum suppression involves computing Intersection-over-Union (IoU) of bounding boxes to discard potential duplicates).

Advantageously, the present invention leverages ground point predictions to selectively avoid discarding true positives by analysing the distance between “object” ground points.

Two criteria are utilized to perform non maximum suppression: (1) if the predicted ground points of two objects are very close to each other, the present invention counts them as the same object (i.e., person). (2) If the predicted ground points are sufficiently far apart from each other, despite having small bounding box sizes, the present invention retains both boxes since they likely belong to different objects (i.e., people) located near the edge of the wide/ultra-wide angle lens image. Advantageously, this unique approach allows for higher recall compared to other solutions.

As discussed above, the various embodiments, or selected steps in the embodiments can be implemented in a wide variety of operating environments, which in some cases can include one or more user computers, computing devices, or processing devices which can be used to operate the system and method of the present invention. Various aspects also can be implemented as part of at least one service or web service, such as can be part of a service-oriented architecture.

Some embodiments may utilize at least one network that would be familiar to those skilled in the art for supporting communications using any of a variety of commercially available protocols, such as TCP/IP, OSI, FTP, uPnP, NFS, and CIFS.

The network can be, for example, a local area network, a wide-area network, a virtual private network, the Internet, an intranet, an extranet, a public switched telephone network, an infrared network, a wireless network, and any suitable combination thereof.

The environment can include a variety of data stores and other memory and storage media as discussed above. These can reside in a variety of locations, such as on a storage medium local to (and/or resident in) one or more of the computers or remote from any or all of the computers across the network. In some embodiments, information can reside in a storage-area network (“SAN”) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad, camera), and at least one output device (e.g., a display device, printer, speaker or camera). Such a system can also include one or more storage devices, such as disk drives, optical storage devices, and solid-state storage devices such as random-access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternative embodiments can have numerous variations from that described above.

For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by a system device.

Embodiments of the present disclosure can be provided as a computer program product including a non-transitory machine-readable storage medium having stored thereon instructions (in compressed or uncompressed form) that can be used to program a computer (or other electronic device) to perform processes or methods described herein. The machine-readable storage medium can include, but is not limited to, hard drives, floppy diskettes, optical disks, CD-ROMs, DVDs, read-only memories (ROMs), random access memories (RAMs), EPROMS, EEPROMs, flash memory, magnetic or optical cards, solid-state memory devices, or other types of media/machine-readable medium suitable for storing electronic instructions. Further, embodiments can also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks. For example, distribution of software can be via Internet download.

While the invention has been described in conjunction with a limited number of embodiments, it will be appreciated by those skilled in the art that many alternatives, modifications and variations in light of the foregoing description are possible. Accordingly, the present invention is intended to embrace all such alternatives, modifications and variations as may fall within the spirit and scope of the invention as disclosed.

The invention claimed is:

1-34. (canceled)

35. A method of training a neural network model for ‘n’ iterations on an object recognition dataset for wide/ultra-wide angle lens object detection and positioning, the method comprising:
(a) receiving one or more images associated with one or more images from the object recognition data set, the data set including one or more bounding box labels associated with the one or more images;
(b) applying a customized data augmentation routine on the images to create one or more augmented images in each new iteration of training;
(c) resizing the one or more images to a predetermined size;
(d) providing a predetermined neural network for computer vision model to test and train the neural network for computer vision;
(e) predicting and obtaining a bounding box and confidence score, each being associated with one or more objects in the one or more images from the neural network for computer vision;
(f) matching ground truth bounding boxes in image space to augmentations from a box data store;
(g) applying regression loss on the bounding boxes; and
(h) computing the cost between predicted values and the label values to determine change in weightings.

36. The method of claim 35, comprising ‘n’ further iterations of:
i) receiving one or more images associated with one or more wide/ultra-wide angle lenses from a primary data set, the primary data set including one or more bounding box and ground point labels associated with the one or more images;
j) applying a customized data augmentation routine on the images to create one or more augmented images;
k) resizing the one or more images to a predetermined size;
l) providing a predetermined neural network for computer vision model to test and train the neural network for computer vision;
m) predicting and obtaining a bounding box, ground point and confidence score, each being associated with one or more objects in the one or more images from the neural network for computer vision;
n) matching ground truth bounding boxes in the Fisheye image space to augmentations from a box data store by applying regression loss on the bounding boxes;
o) matching ground truth ground points in Fisheye image space to augmentations from a ground point data store by applying regression loss on ground points; and
p) computing the cost between predicted values and the label values to determine change in weightings.

37. The method of claim 36, wherein ground points include manually derived real locations where one or more ground points appear in an image.

38. The method of claim 36, wherein training on the primary dataset for box and ground point prediction is carried out to finetune the weights transferred from output through transfer learning and optionally freezing weights.

39. The method of claim 38, wherein the object recognition dataset includes one or more of MSCOCO or a publicly available image recognition dataset,

40. The method of claim 36, wherein (i) to (p) are carried out over a predetermined time period of 300 (grayscale model) epochs or 600 (color model) epochs.

41. The method of claim 36, wherein at (p), the cost is computed by a cost function, which includes: regression losses such as (cost BCE with logits loss (class, confidence), IoU loss (boxes) and smooth L1 loss (ground points).

42. The method of claim 35, wherein at (d), the predetermined neural network is based on one or more of depth-wise and point-wise convolutional neural network and object detection heads.

43. The method of claim 35, wherein the predetermined neural network is based on a MobileNetv1 backbone and YOLOv3 head.

44. The method of claim 35, wherein the predetermined neural network is a customized MobileNetv1 backbone and customized YOLOV3 heads.

45. The method of claim 35, wherein the customized MobileNetv1 backbone+customized YOLOv3 heads includes customizing the number of channels each convolution node has to balance accuracy and size.

46. The method of claim 35, wherein at (b) or (j), the one or more augmented images are augmented based on a change of parameter of the image.

47. The method of claim 46, wherein the parameter of the images includes one or more of hue, saturation, image rotation, scale augmentation, flip up-down augmentation, flip left-right augmentation, mosaic, contrast limited adaptive histogram equalization (CLAHE), brightness, contrast, random gamma correction, image compression, generating MJPEG image compression artefacts, channel shuffle, channel dropout, gaussian noise, motion blur, RGB shift.

48. The method of claim 46, wherein a probability is applied to the one or more parameters.

49. The method of claim 35, wherein ‘n’ iterations of (a) through (h) are carried out until a sufficiently optimum baseline neural network is attained to transfer weights, and the method used during any of the ‘n’ iterations further comprises:
(i) training with an object recognition dataset for box prediction; and
(ii) training on the object recognition dataset, using heavy rotation and flip augmentation for box prediction

50. The method of claim 35, wherein (a) through (h) are carried out over a first predetermined time period.

51. The method of claim 50, wherein the first predetermined time period is 300 epochs and the second predetermined time period is 1200 epochs.

52. The method of claim 35, wherein at (h), the cost is computed by a cost function, which includes: regression losses such as (cost BCE with logits loss (class, confidence), IoU loss (boxes).

53. A method for inference of a neural network model for wide/ultra-wide angle lens object and positioning, the method comprising:
a) capturing an image from the wide/ultra-wide angle lens;
b) cropping the captured image around the center of the wide/ultra-wide angle lens;
c) normalising pixel values associated with the captured image;
d) filling Field Programmable Gate Array Programmable Logic buffers;
e) running the neural network;
f) predicting bounding boxes, confidences and ground points;
g) decoding bounding boxes and ground points;
h) filtering by confidence;
i) determining if confidence is higher than a predetermined threshold and if higher, compute box angles using arctan 2(box_centre, image_center);
j) using a ground point distance between predictions to avoid discarding far away boxes that have high area overlap;
k) computing intersection over sample for pair of predictions; and
l) determining if Intersection over Sample (IoS) is higher than a predetermined threshold and if below threshold, output predictions for box, ground points and confidence.

54. A system comprising:
one or more processors; and
a memory, communicatively coupled to the one or more processors, for storing a neural network training module for training of a neural network model for wide/ultra-wide angle lens object detection and positioning, the neural network training module configured to:
a) receive one or more images associated with one or more images from the object recognition data set, the data set including one or more bounding box labels associated with the one or more images.
b) apply a customized data augmentation routine on the images to create one or more augmented images in each new iteration of training;
c) resize the one or more images to a predetermined size;
d) provide a predetermined neural network for computer vision model to test and train the neural network for computer vision;
e) predict and obtain a bounding box and confidence score, each being associated with one or more objects in the one or more images from the neural network for computer vision;
f) match ground truth bounding boxes in image space to augmentations from a box data store;
g) apply regression loss on the bounding boxes;
h) compute the cost between predicted values and the label values to determine change in weightings.
